(19) United States
(12) Patent Application Publication
(10) Pub. No.: US 2011/0056397 A1
(43) Pub. Date: Mar. 10, 2011

(54) JACKET FOR IMPRESSION CYLINDER OR TRANSFER CYLINDER AND METHOD FOR MANUFACTURING THE SAME

(76) Inventors: Yoshiki NISHIKAWA, Ota-ku (JP); Kenichi Misawa, Ota-ku (JP)

(21) Appl. No.: 12/787,543

(22) Filed: May 26, 2010

(30) Foreign Application Priority Data
Sep. 8, 2009 (JP) 2009-207058

(51) Int. Cl. B41F 13/18; B21K 1/02

(52) U.S. Cl. 101/375; 29/895

(57) ABSTRACT

A composite structure for application to an impression cylinder or a transfer cylinder includes an ink smear preventing sheet having flexibility as a whole backed by a flexible metal thin plate. The work surface of the ink smear preventing sheet has an ink smear preventing structure in the form of a concave-convex configuration. The ink smear preventing sheet is of a flexible sheet of resin having an adhesive layer thereon in which are partially embedded many small balls to form the concave-convex structure.

### BACKGROUND OF THE INVENTION

Generally, as an impression cylinder of an offset printing press, there is used a cylinder made of metal, having the surface finished with chrome plating. In offset printing, as is shown in FIG. 1, ink is transferred from a plate cylinder 1 to a blanket cylinder 2 and, thereafter, is pressed and transferred onto one surface of a printing substrate 4, fed between the blanket cylinder 2 and an impression cylinder 3, to form an ink image 5. Subsequently, when printing is to be performed on the reverse surface of the printing substrate (printing on both sides), the printing substrate 4 is printed in the next process on the reverse surface by feeding the substrate in an inverted state between a blanket cylinder 2 and the impression cylinder 3 which are constituted in the same way as above. In this process, as shown in FIG. 2, the ink image 5 which was printed first is transferred onto the impression cylinder 3 as a transferred ink image 6 and, then, this transferred ink image 6 is retransferred onto one surface of the printing substrate 4 which is fed continuously. Thus, as a result, a problem is that the printing surface becomes smeared. When this printing on both sides is repeated, the smearing of the printing surface becomes worse, resulting in occurrence of uneven printing and setting off.

Thus, as a jacket to cover the impression cylinder 3, there was developed one described in Japanese Patent Laid-Open No. H8-12151. This is a covering body (a jacket) to be wound detachably around the entire peripheral surface of the impression cylinder 3 and comprises a degreased and blast-treated metal plate material, for example, an aluminum plate (including an alloy) or a stainless steel plate having a thickness of 0.1 to 0.5 mm. On this plate is formed a porous, thermally sprayed ceramic layer and, on the surface and inside of the pores thereof, a silicone resin layer. Further, a smooth concave-convex structure having a surface roughness, Rmax, of 20 to 40 μm is formed, making it difficult for the ink to adhere to the surface and, thus, preventing smearing with ink.

Also known in the prior art, for example U.S. Pat. No. 6,203,914, is an ink smear preventive sheet in the form of an ink smear preventive structure having a concave-convex surface on a flexible sheet substrate made of a resin.

### SUMMARY OF THE INVENTION

The jacket described in the Japanese Patent Laid-Open No. H8-12151, when the metal plate is supposedly formed of a 0.1 mm thick aluminum plate, has a thickness a little thicker than aluminum foil. When formation of a thermally sprayed ceramic layer having an average thickness of 30 to 200 μm is tried on the surface thereof, it is impossible to form a thermally sprayed layer having a film thickness greater than 100 μm on the aluminum plate having a thickness of 0.1 mm, namely 100 μm. Unless the plate has a thickness greater than 0.25 mm, it is regarded as difficult to form a thermally sprayed ceramic layer having an average film thickness of 30 to 80 μm by means of plasma spraying, arc spraying, or gas spraying. This is true not only with the aluminum plate but also with a stainless steel plate. Even if a thermally sprayed layer having an average thickness of 30 to 80 μm could be formed by plasma spraying on a metal plate having a thickness of 0.1 mm (100 μm), there has been a fear that, when winding this metal plate around the impression cylinder or transfer cylinder, the metal plate might be dented, twisted, or bent, so that its back surface may not be pressed closely against the cylinder. Further, when the metal plate is thick and has high hardness and high rigidity, the work of winding the plate around the cylinder has been a heavy burden and has required shutdown of the printing press for a long time. Especially, with a cylinder having a diameter as small as about 180 mm, when the metal plate is thick and has small deflection, the winding work becomes increasingly difficult and, if the plate is forcedly wound, there is a fear that it may be damaged.

Accordingly, an object of the present invention is to provide a jacket for an impression cylinder or a transfer cylinder and a method for manufacturing the same, the jacket being able to prevent ink smearing and allow easy and precise winding around the impression cylinder or the transfer cylinder, and to exhibit a smear preventive function for a long period of time.

In order to accomplish the above object, the jacket for the impression cylinder or a transfer cylinder of the present invention comprises a composite structure, which is constituted of an ink smear preventive sheet having flexibility as a whole, the ink smear preventive sheet being in the form of an ink smear preventive structure having a concave-convex surface on a flexible sheet substrate made of a resin, and a flexible metal thin plate on the back surface of the ink smear preventive sheet.

Further, a method for manufacturing the jacket for an impression cylinder or a transfer cylinder of the present invention comprises: forming an ink smear preventive sheet having flexibility as a whole by providing an ink smear preventive structure having a concave-convex surface on a surface of a flexible sheet substrate made of a resin and winding the ink smear preventive sheet into the form of a roll; while pulling out the ink smear preventive sheet, superposing a metal thin plate on the back surface thereof; and pressing the sheet and the plate with an adhesive interposed between the superposing surfaces and cutting the pressed two-layer structure to a predetermined size. Furthermore, the metal thin plate to be superposed on the back surface of the ink smear preventive sheet wound into the form of a roll may be wound into the form of a roll and the respective materials being unwound from the two rolls, namely the roll of the ink smear preventive sheet and the roll of the metal thin plate, may be superposed and pressed together at sites of press rolls or the metal thin plate may be superposed on the back surface of the ink smear preventive sheet as a plate cut to a predetermined size.

In the present invention, because an ink smear preventive sheet having flexibility as a whole is formed by providing an ink smear preventive structure having a concave-convex surface on the surface of a flexible sheet substrate made of a resin and the composite structure which is to be formed into a jacket is completed by providing a flexible metal thin plate on the back surface of the ink smear preventive sheet, the jacket, in comparison to one according to Japanese Patent Laid-Open No. H8-12151, is not so thin as to dent or break (because of the two-layer structure, namely, ink smear preventive sheet layer and metal thin plate layer), has a good shape-maintaining property due to the presence of an ink smear preventive sheet without making the metal thin plate thicker, and, moreover, has sufficient flexibility as a whole. Thus, it is easy to wind the jacket around an impression cylinder or a transfer cylinder. Also, stretching of the ink smear preventive sheet is suppressed by the metal thin plate and any defects which might otherwise be caused by the thinness of the metal thin plate are compensated for by the ink smear preventive sheet. Thus, the jacket can adapt to the shape of the impression cylinder or the transfer cylinder better, making precise winding and a lighter work burden possible.

A method for manufacturing a jacket of the present invention comprises forming an ink smear preventive sheet having flexibility as a whole by providing an ink smear preventive structure having a concave-convex surface on a surface of a flexible sheet substrate made of a resin and winding the ink smear preventive sheet into the form of a roll; while pulling out the ink smear preventive sheet, superposing a metal thin plate on the back surface thereof; and pressing the sheet and the plate with an adhesive interposed between the superposing surfaces and cutting the pressed two-layer structure to a predetermined size. Thus, the ink smear preventive sheet manufactured beforehand can be wound and stored, and, therefore, the ink smear preventive sheet can be mass produced to reduce costs. Alternatively, the composite structure for the jacket can be manufactured by pulling out the sheet from a roll by a predetermined length according to need, superposing and pressing the sheet metal thin plate with an adhesive interposed therebetween, and cutting the thus formed composite structure to a size suitable for the jacket. Further, by regulating the gap between the press rolls used to press the sheet and plate together to a constant value at the time of pressing, a jacket having good thickness precision can be manufactured. Thus, in a multi color printing press such as one which prints four colors on one surface and four colors on the back surface, there will be no difference in the cylinder diameter between the respective impression cylinders. Alternatively, in a type where two jackets are installed on a periphery of an impression cylinder referred to as a double-diameter cylinder, the thickness of the two jackets is kept uniform and, thus, uniform printing becomes possible. Also, even when one jacket is damaged and is replaced with a new one, the jacket has uniformity with the remaining one, thus uneven printing does not occur.

### BRIEF DESCRIPTION OF THE DRAWINGS

FIG. 1 is a view showing a state of printing at a conventional impression cylinder section;

FIG. 2 is a view explaining a conventional defect;

FIG. 3 is a partially enlarged cross-sectional view of an embodiment of the present invention;

FIG. 4 is an enlarged cross-sectional view of an ink smear preventive sheet;

FIG. 5A is an explanatory view of a method for manufacturing a jacket;

FIG. 5B is an explanatory view of another method for manufacturing a jacket;

FIG. 6 is a side view of a state of attachment of a jacket to an impression cylinder; and

FIG. 7 is an enlarged cross-sectional view of another embodiment.

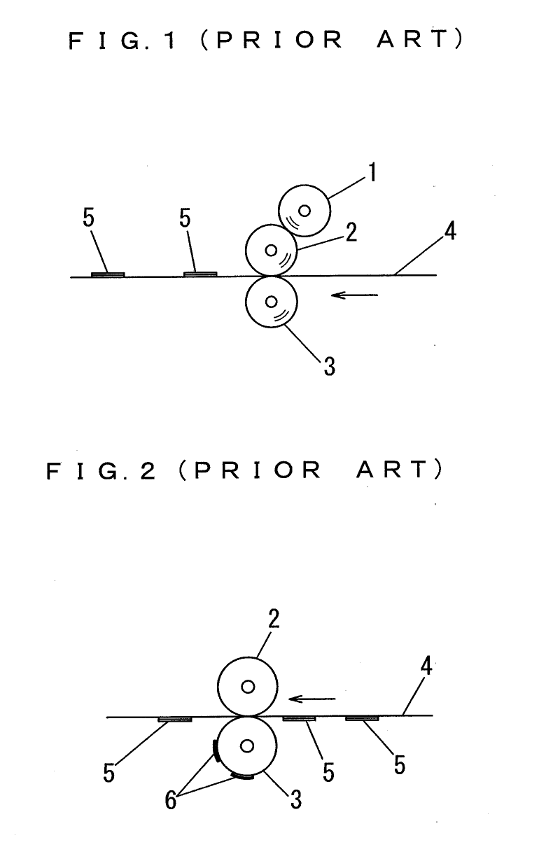

### DETAILED DESCRIPTION OF THE INVENTION

Hereinafter, preferable embodiments of the present invention will be described with reference to the drawings.

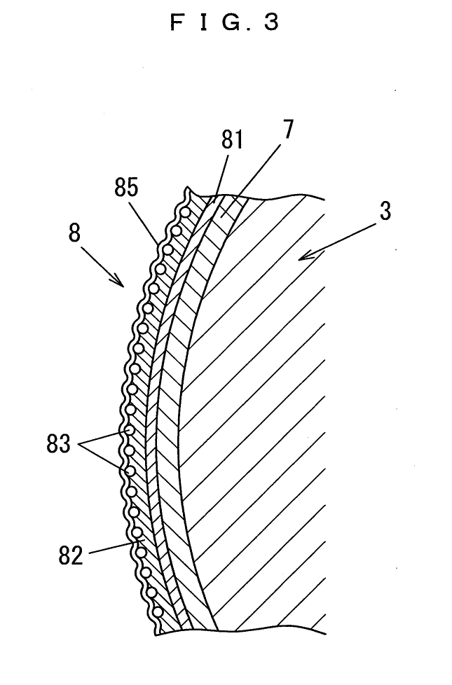

FIG. 3 is a partially enlarged cross-sectional view of a jacket according to the present invention which is wound around an impression cylinder 3, and shows the jacket comprising a two-layer structure comprising a flexible metal thin plate 7 having a thickness of 0.10 to 0.30 mm and a flexible ink smear preventive sheet 8. The ink smear preventive sheet 8 comprises an ink smear preventive structure provided on the surface of a flexible sheet substrate 81 made of a resin. An example of this ink smear preventive structure includes an adhesive layer 82 provided on the sheet substrate 81, with small balls 83 being partially embedded in the adhesive layer 82, and a cured resin layer 85 being formed of a low surface-energy resin on the exposed convex portions of these small balls 83, this surface layer (the cured resin layer 85) having a convex-concave surface (with surface roughness, Rmax, being about 20 to 70 μm).

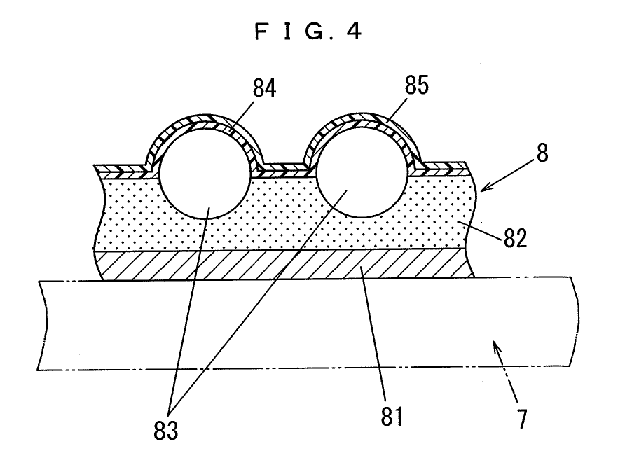

FIG. 4 shows details of the ink smear preventive sheet 8. As the sheet substrate 81, there may be suitably used a film made of a resin, preferably polyester, polyethylene terephthalate, a textile fabric made of a resin, or the like. In addition to these, there may be used other materials provided that they have surface smoothness and flexibility. Among these, polyester film is preferable as the sheet substrate 81 because it has excellent properties from all of mechanical, electrical, chemical, thermal, and other aspects, and has excellent quality stability and surface smoothness. Further, in case of a textile fabric, a flat-woven polyester fabric is preferable.

As an adhesive which forms the adhesive layer 82, there may be used polyolefin and polyester adhesives, for example, polyethylene, which can resist cleaning oil (high boiling point petroleum solvents). Further, it is possible to color the adhesive layer 82 by incorporating coloring pigments.

The small balls 83 partially embedded in the adhesive layer 82 include glass beads, small balls made of plastics, or small balls made of ceramics. In addition, as the small balls made of plastics, for example, polyacrylate beads are preferable. Further, when ceramics are used, there may be used one made of a material such as, for example, aluminum oxide. Preferable are small balls 83 obtained by using soda glass containing barium titanate. In addition, the range of the size of these small balls 83 is preferably about 30 μm to 200 μm in diameter. This is so because, with a size less than 30 μm, a function as a point contact mechanism becomes poor and with a size exceeding 200 μm, there arises a fear of damaging the printing material. The size of the small balls 83 is suitably chosen from the range of 30 μm to 200 μm depending on the kind of printing material, printing speed, thickness of the printing material, the presence or absence of gloss varnishing, and the like.

Meanwhile, on the small ball 83 is coated a thin film layer 84, on which a cured resin layer 85 is formed. The thin film layer 84 may comprise a urethane resin adhesive composition and becomes a primer layer. This primer layer may be constituted of an adhesive composition comprising a urethane resin obtained from a polyol compound and a diol compound (chain extender), and a polyisocyanate crosslinking compound. The thickness of this layer is set in a range of about 1 to 10 μm. Further, the cured resin layer 85 may be a layer of a polyurethane-silicone copolymer, coated on the thin film layer 84 provided on the small balls 83. As the cured resin layer 85, a fluororesin may also be used. Further, there may be used a cured resin layer 85, in which a coloring pigment is incorporated.

On the sheet substrate 81, the adhesive layer 82 is coated beforehand by means of knife coating and the like. This adhesive layer 82 and a strippable member wherein the small balls 83 are embedded are bonded, heated, and pressed. By moisturizing the paper included in the strippable member, strength of the paper is restored and the strippable member is peeled off leaving the small balls 83 embedded in the adhesive layer 82. In this way, the upper extremity of the exposed top portion of each of the small balls 83, which are all of the same size, are all in the same plane. As another manufacturing method, the adhesive layer 82 is coated on the sheet substrate 81 by means of a T-die extrusion coater and, on this adhesive layer 82, the small balls 83 are distributed uniformly. By heating the adhesive layer 82, the resin of this layer 82 becomes soft, thereby embedding the small balls 83 in a depth corresponding to about 5 to 40% of the diameter of the small balls 83. After cooling, the small balls 83 become fixed.

When the small balls 83 are thus embedded in the surface as exposed convex portions, the cured resin layer 85 is coated on the exposed convex portions of the small balls 83 so that the shape of the convex remains on the surface.

The cured resin layer 85 may be any provided that it (1) can be coated uniformly on the small balls 83, (2) has abrasion resistance and a mold-release property, (3) is chemically stable without migration to the printing paper, and (4) has durability (oil resistance) against cleaning oil. As a material which satisfies these requirements, a polyurethane-silicone copolymer is suitable. The thickness of this cured resin layer 85 is set at about 5 μm.

With the urethane resin adhesive composition which constitutes the thin film layer 84 as a primer layer, a silane coupling agent alone or together with a silicon isocyanate compound may be used for the purpose of improving the adhesive strength between the composition and the glass beads. Alternatively, this may be used as a primer layer, for example, two-component polymers and a silane coupling agent, the two-component polymers including compositions such as a two-component epoxy resin, for example, Epikote 828 (manufactured by Shell Chemical Co.) and a hardening agent, diethylenetriamine, which forms a polyamide; and an acrylic prepolymer having terminal hydroxyl groups or amino groups and an isocyanate hardener; a vinyl polymer having hydroxyl groups such as Vinylite VAGA (Union Carbide Corp.) and an isocyanate hardener; a polyester and an isocyanate hardener. This primer layer is coated on the small balls 83 in a small amount and uniformly, and can bond the small balls 83 and the cured resin layer 85 strongly. When the material of the small balls 83 is plastic or glass, a two-component urethane resin is preferable as the primer layer. By isocyanate crosslinking of the two-component urethane, adhesion strength between the small balls 83 and the cured resin layer 85 can be improved and, at the same time, oil resistance thereof can be upgraded.

As the metal thin plate 7, there may preferably be used aluminum, an aluminum alloy, stainless steel, a tin-plated steel, a galvanized steel, a nickel-plated steel, an SS material, and a tin-free steel, the thickness thereof being set in a range of 0.10 to 0.30 mm. In addition, the total thickness of the two-layer structure obtained by superposing the metal thin plate 7 and the ink smear preventive sheet 8 is set in a range of 0.25 to 0.50 mm.

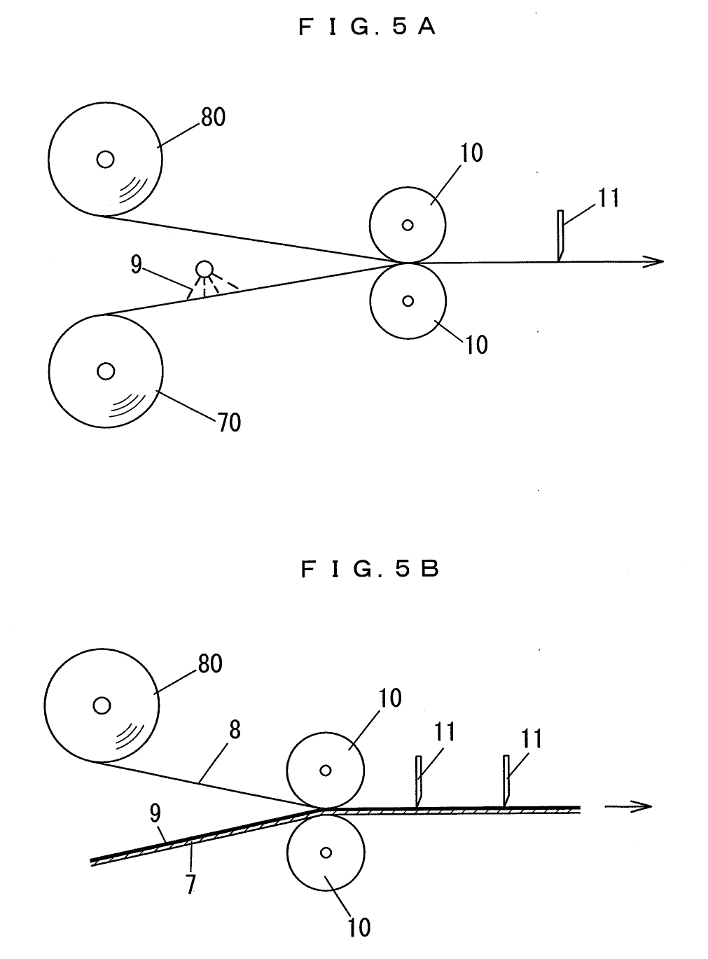

FIG. 5A shows a view which describes a method for manufacturing a jacket for an impression cylinder. An ink smear preventive sheet 8, having a convex-concave surface with surface roughness, Rmax, of 20 to 70 μm formed on its surface, is wound into the form of a roll and such a roll 80 is manufactured beforehand by providing an adhesive layer 82 on a flexible sheet substrate 81 made of a resin, partially embedding a large number of small balls 83 in the adhesive layer 82, and forming a cured resin layer 85 by coating a low-surface energy resin, for example, a silicone resin or a fluororesin on the exposed convex portions of the small balls. Similarly, a roll 70 is also prepared by winding a metal thin plate 7 into the form of a roll. A jacket for an impression cylinder is manufactured by pulling out the ink smear preventive sheet 8 and the metal thin plate 7 from the two rolls 70 and 80, transferring the same in such a way that the metal thin plate 7 becomes superposed on the back surface of the ink smear preventive sheet 8, interposing an adhesive 9 between the superposed surfaces of the sheet and the plate, pressing the two by press rolls 10 to produce a two-layer structure, and cutting this two-layer structure to a predetermined size by a cutter 11. The position to cut by the cutter 11 is appropriately changed depending on the diameter of an impression cylinder and the like. As the cutter 11, a laser cutter is suitably used. In addition, as shown in FIG. 5B, there is a case where it is inconvenient to have the metal thin plate 7 wound as a roll 70 depending on its thickness. In such a case, a belt-like metal thin plate 7 having the adhesive 9 coated thereon may be superposed and pressed together with the ink smear preventive sheet 8, which has been manufactured beforehand and stored in the form of a roll, by the press rolls 10 and cut to a predetermined size in the next step. Meanwhile, instead of using the belt-like metal thin plate as in FIG. 5B, it is also possible to coat the adhesive 9 on an upper surface of the metal thin plate 7 cut to a predetermined size, superpose the plate on the lower surface of the belt-like ink smear preventive sheet 8, bonding them by pressing, followed by cutting the belt-like ink smear preventive sheet 8 to the size of the metal thin plate 7. As the adhesive 9, there may be used a saturated polyester resin, a polyurethane resin, a modified epoxy resin, and the like.

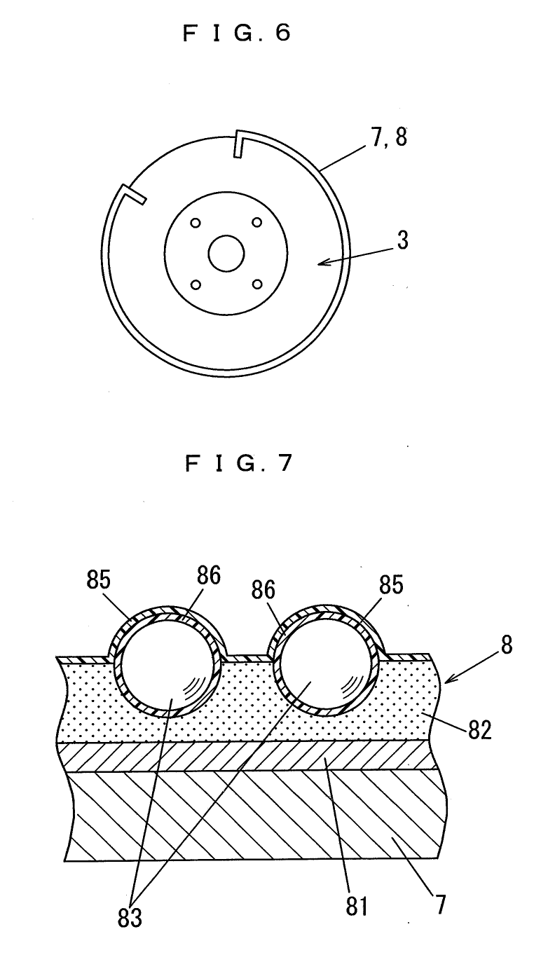

FIG. 6 shows a state where a jacket wound tightly around the outer peripheral surface of the impression cylinder 3 after bending and inserting the ends of the jacket into grooves formed on the impression cylinder 3 to engage the jacket. As for the pulling torque when mounting the jacket, namely the force required to pull the jacket to wind around the impression cylinder 3 after inserting one end of the jacket into one of the grooves on the impression cylinder 3, 100 N is enough to wind the jacket precisely around the outer peripheral surface of the impression cylinder 3. In this particular case, the impression cylinder is of a DAIYATP Two-color machine (diameter, 580 mm), manufactured by Mitsubishi Heavy Ind., Ltd., the jacket being prepared by bonding a galvanized steel plate (the metal thin plate 7) of a thickness of 0.1 mm on the ink smear preventive sheet 8 having surface roughness, Rmax, of the convex-concave surface of 30 μm to bring the total thickness to 0.3 mm, the ink smear preventive sheet being prepared using a polyethylene terephthalate (PET) film as the sheet substrate 81, glass beads as the small balls 83, and a silicone resin as the cured resin layer 85. In addition, in a printing test after mounting of the jacket, there is no trouble in registrability of the front and back surfaces, smearing, and blemishes. Also, printing quality on the front and back surfaces is the same. Further, there is no change (deterioration) in printing quality in a printing test of 10 million sheets.

The jacket of an embodiment shown in FIG. 7 is produced by forming a thin film layer 86 on the entire surface of the small balls 83 by treating the surface of the small balls 83 made of an inorganic material with a silane coupling agent and using a polyurethane-silicone copolymer resin as the cured resin layer 85. In this embodiment, adhesion between the thin film layer 86 formed of the silane coupling agent and the polyurethane-silicone copolymer becomes strong and, when forming the cured resin layer 85, the resin does not flow into the valleys between the small balls 83 to make the valleys shallow. In addition, adhesion between the adhesive layer 82 and the small balls 83 becomes stronger due to the silane coupling agent. Because the valley between the small balls 83 is deep, ink smearing, if any, is restricted to the tip of the small balls 83. Thus, the interval between cleaning of adhered ink can be made longer and the time necessary for maintenance can be shortened. Durability of the jacket was also improved dramatically because of decrease in frequency of cleaning and improvement in adhesion strength of the small balls 83 to the adhesive layer 82 and the cured resin layer 85.

As the silane coupling agent, an amino silane coupling agent having the following formula is used.

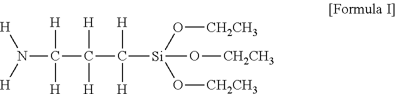

Into 150 g of this amino silane coupling agent diluted with 1.5 kg of ethanol, a diluting solvent, there was mixed 500 kg of small balls 83 (glass beads). The mixture was stirred continuously at ordinary temperature for 50 minutes and, thereafter, allowed to stand at 100° C. for 10 minutes to evaporate the ethanol component. After evaporation of ethanol, there was formed on the small balls 83 a thin film layer 86 due to the coupling agent, having a thickness of 5 nm (50 Å).

It is well known that the silane coupling agent can act as an intermediary to bond an inorganic component and an organic component, which are intrinsically incompatible. The silane coupling agent has a hydrolyzable group (example: an alkoxy group) which is compatible with an inorganic material and, within the same molecule, an organic functional group which easily reacts with an organic component. And, the agent reacts with glass, metal, and the like through the hydrolyzable group and combines with organic components through various organic functional groups. In case of the present invention, there are the small balls 83 (glass and the like) as an inorganic material and a polyurethane-silicone copolymer (the cured resin layer 85) as an organic resin. The silane coupling agent (the thin film layer 86) acts as an intermediary between these materials.

As the silane coupling agent, the amino type shows the most excellent adhesion strength but an epoxy, acryl, vinyl, or mercapto type can also be used, even though these show lower adhesion strength than that of the amino type. When a sheet according to the working example in U.S. Pat. No. 6,203,914 and a sheet of the present invention, obtained by using an amino silane coupling agent and small balls 83 made of soda glass containing barium titanate, is subjected to an immersion test (48 hours) in a toluene solvent, superiority of the sheet of the present invention with respect to its resistance to the solvent is clear.

The ink smear preventive sheet 8 shown in FIG. 7 is one obtained by forming a thin film layer 86 of an amino silane coupling agent of Formula I on the surface of the small balls 83 in a thickness of 0.5 nm and, further, forming thereon a cured resin layer 85 in a thickness of 4.995 μm (the total thickness is 5 μm, the same as the conventional one). The thickness of the outermost layer became 2.5 times as large as the conventional one, namely the cured resin layer 85 became thicker, and the shape of the convex portion of the small balls 83 became sharper compared to the one coated with the aforementioned thin film. layer 84. As effects synergistic with the foregoing, there were found such effects as that durability was improved, that frequency of ink removing work decreased, that detachment of the small balls 83 occurred less, that elongation due to change over time of use became less, that the product life was prolonged, that bending strength was improved retention of flexibility, and that heat resistance temperature went up.

In the above-described Examples, a jacket for the impression cylinder and a method for manufacturing the same were described but the same description applies to a jacket for the transfer cylinder.

What is claimed is:

1. A composite structure for application to an impression cylinder or a transfer cylinder as a jacket, comprising:
an ink smear preventive sheet having flexibility as a whole comprising a flexible sheet substrate comprised of a resin and, on a front surface of the substrate, an ink smear preventive structure having a concave-convex surface; and
a flexible metal thin plate on a back surface of the substrate.

2. The composite structure according to claim 1, wherein the ink smear preventive sheet further comprises an adhesive layer on the front surface of the sheet substrate, a plurality of small balls partially embedded in the adhesive layer, and, on non-embedded surfaces of the balls and surfaces of the adhesive layer therebetween, a coating comprising a cured, low surface energy resin, the non-embedded coated surfaces of the balls together with the coated surfaces of the adhesive layer therebetween forming the concave-convex surface.

3. The composite structure according to claim 1, wherein surface roughness, Rmax, of the concave-convex surface is 20 to 70 μm.

4. The composite structure according to claim 1, wherein the flexible metal thin plate is constituted of any one selected from aluminum or an alloy thereof, stainless steel, tin-plated steel, galvanized steel, nickel-plated steel, an SS material, and tin-free steel.

5. The composite structure according to claim 1, wherein thickness of the metal thin plate is 0.10 to 0.30 mm.

6. The composite structure according to claim 1, wherein total thickness of the metal thin plate together with the ink smear preventive sheet is 0.25 to 0.50 mm.

7. The composite structure according to claim 2, wherein the low surface energy resin comprises a silicone resin or a fluororesin.

8. The composite structure according to claim 2, further comprising a thin film layer on surfaces of the small balls and contacting the cured resin layer, the thin film layer comprising a silane coupling agent.

9. The composite structure according to claim 8, wherein the silane coupling agent comprises an amino silane coupling agent.

10. The composite structure according to claim 8, wherein the amino silane coupling agent is of the following Formula I:

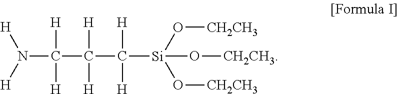

11. The composite structure according to claim 10, wherein the cured resin layer comprises a polyurethane-silicone copolymer.

12. A method for manufacturing a composite structure suitable for application to an impression cylinder or a transfer cylinder as a jacket, comprising:
forming an ink smear preventive sheet having flexibility as a whole comprising a flexible sheet substrate comprised of a resin and, on a front surface of the substrate, an ink smear preventive structure having a concave-convex surface and winding the ink smear preventive sheet into the form of a roll;
while unwinding the ink smear preventive sheet from the roll, superposing a flexible metal thin plate on a back surface thereof; and
pressing the sheet and the plate with an adhesive interposed between superposed surfaces of the ink preventive sheet and the plate.

13. The method according to claim 12, further comprising winding the metal thin plate to be superposed on the back surface of the ink smear preventive sheet into the form of a roll wherein the thin metal plate is unwound from the roll thereof while the ink smear preventive sheet is unwound from the roll thereof and the pressing is effected by press rolls.

14. The method according to claim 12, further comprising cutting the metal thin plate to a predetermined size before superposing it on the back surface of the ink smear preventive sheet.

15. The method according to claim 12, wherein the forming of the ink smear preventive sheet comprises providing an adhesive layer on the flexible sheet substrate, partially embedding a plurality of small balls in the adhesive layer, and forming a cured resin layer by coating a low surface energy resin on exposed convex portions of the small balls.

16. The method according to claim 12, wherein a surface roughness, Rmax, of the concave-convex surface is set at 20 to 70 μm.

17. The method according to claim 12, wherein the metal thin plate is constituted of any one selected from aluminum or an alloy thereof, stainless steel, tin-plated steel, galvanized steel, nickel-plated steel, an SS material, and tin-free-steel.

18. The method according to claim 12, wherein thickness of the metal thin plate is 0.10 to 0.30 mm.

19. The method according to claim 12, wherein total thickness of the metal thin plate together with the ink smear preventive sheet is 0.25 to 0.50 mm.

20. The method according to claim 15, wherein the low surface energy resin comprises a silicone resin or a fluororesin.

21. The method according to claim 15, further comprising applying a thin film layer onto surfaces of the small balls before embedding the small balls in the adhesive layer whereby portions of the thin film layer are situated between surfaces of the small balls and the cured resin layer.

22. A jacket for an impression cylinder or as a transfer cylinder comprising the composite structure of claim 1.

23. An impression cylinder or a transfer cylinder having the jacket of claim 22.
